(19) United States
(12) Patent Application Publication
(10) Pub. No.: US 2012/0119035 A1
(43) Pub. Date: May 17, 2012

(54) Collapsible space shuttle

(76) Inventor: Issam Sharif, Vienna (AT)

(21) Appl. No.: 11/919,914

(22) PCT Filed: Nov. 27, 2006
(86) PCT No.: PCT/AT2006/000486

§ 371 Date: Jan. 26, 2010

(30) Foreign Application Priority Data
Nov. 29, 2005 (AT) A 1922/2005

(51) Int. Cl. B64G 1/14; B64B 1/02

(52) U.S. Cl. 244/158.9

(57) ABSTRACT

The invention relates to an airship which can be unfolded and folded up automatically on the ground and during flight and which can be operated as an aircraft or as a reusable space shuttle, having a combined collapsible gas cell (400), a grid network (600) which provides the shape, an aircraft body (200) comprising a cockpit (210), a cargo bay (220), a machine bay (230) and collapsible wheels (240), components for aircraft navigation control (300), two rocket motors (500L, 500R) which can be rotated, a collapsible control surface (700) and a mechanism for operation of the collapsible control surface (100). The combined collapsible gas cell (400) comprises an envelope (402) which can be folded and a housing (401) which cannot be folded. The housing (401) which cannot be folded is mounted on the inner walls and the bottom of the cargo bay (220). The gas cell (400) is filled with helium or hydrogen in the unfolded state, and is completely empty in the collapsed state. The envelope (402) which can be folded is held by the grid network (600) which provides the shape when in the unfolded state, and is located in the internal area of the housing (401), which cannot be folded, in the collapsed state.

The invention relates to an airship which can be unfolded and folded up automatically on the ground and during flight and which can be operated as an aircraft or as a reusable space shuttle, having a combined collapsible gas cell, a grid network which provides the shape, an aircraft body comprising a cockpit, a cargo bay, a machine bay and collapsible wheels, components for aircraft navigation control, two rocket motors which can be rotated, a collapsible rudder-wing, a mechanism for operation of the collapsible rudder-wing, a liquefaction plant for Helium, fuel cells, a pressure tank for helium, a pressure tank for oxygen, a pressure tank for hydrogen, a vacuum pump.

A heavier than air hybrid airship, with a static and a dynamic lift is known from U.S. Pat. No. 4,838,501 A1. The subject matter of this invention lies in the capability of the flying machine in taking-off by means of a static and a dynamic lift. The static lift is generated by means of a heatable lift gas bag. The dynamic lift is generated by means of two pivotable power plants. The forward thrust is generated by means of the mentioned pivotable power plants. The flying machine is provided in addition with two deflectors for generating additional lift while in forward flight. The air resistance while in forward flight would, thereby, be reduced in comparison to that resulting in the case of traditional lighter than air airships. The disadvantage of this airship lies in the fact that the take-off is not entirely accomplished by means of a statistic buoyancy. Furthermore, the loss caused by air resistance remains relatively high in comparison to aircrafts despite the use of deflectors.

A variable geometry lighter-than-air airship is known from U.S. Pat. No. 5,005,783 A1. The subject matter of this invention lies in the capability of the airship to change while in flight from a buoyant airship to a heavier-than-air craft by changing shape. The change of the shape while in flight is realized on the basis of creating pressure in the flexible envelope of the airship. The additionally required lift while in forward flight is generated by means of two flexible wing expansion sections. Thereby the air resistance during forward flight would be reduced in comparison with that resulting in the case of traditional lighter than air airships. As in the case of the above mentioned hybrid airship the air resistance remains rather high in comparison with aircrafts. Furthermore, because of their dependency on light gas for buoyancy, both flying machines are only qualified for flying in the earth's atmosphere and could, therefore, not be used for a space flight.

A great number of aircraft types are known from the state of the art. All types of these aircrafts, including helicopters have the disadvantage of consuming huge propellant during take-off because of the complete dependency on the dynamic lift.

A number of sub-orbital reusable space shuttles are known from the state of the art. These space shuttles have the disadvantage of having high fixed costs and high propellant consumption requirements in addition to technical complications, such as the dependency on special airports or on launching pads for taking-off and on parachutes for landing in addition to other shortcomings during take-off, such as noise and pollution caused by emissions.

In contrast to this, the task of the present invention is to create an airship which is capable of unfolding and folding up automatically on the ground and during flight and which can be operated as an aircraft or as a reusable space shuttle. Such an airship must be capable of accomplishing the entire take-off by means of a static lift, in need must be equally capable of accomplishing the entire take-off by means of a dynamic lift, while in horizontal flight in the earth's atmosphere it must be capable of securing sufficient dynamic lift by means of the wings to offset entirely the force of gravity and hence minimize the losses in thrust caused by air resistance. Such an airship in the configuration of a sub-orbital reusable space shuttle must in addition be capable of flying beyond into the space by means of a dynamic lift.

The invention solves the set task thereby that, the combined collapsible gas cell comprises an envelope which can be folded and a housing which cannot be folded, the housing which cannot be folded is mounted on the inner walls and the bottom of the cargo bay, the combined collapsible gas cell is filled with helium or hydrogen in the unfolded state, and is completely empty in the collapsed state, the envelope which can be folded is held by means of the grid network which provides the shape when in the unfolded state, and is located along with the grid network in the internal area of the housing, which cannot be folded, in the collapsed state.

An airship which can be unfolded and folded up automatically on the ground and during flight and which can be operated as an aircraft or as a sub-orbital reusable space shuttle, takes-off in the unfolded state. It collapses just after the required altitude in the earth's atmosphere has been reached. In the collapsed state the flying machine takes the form of an aircraft. In this way the take-off can be accomplished by means of a static lift and thereby enormous saving in energy consumption can be realized. On the other hand while in forward flight, the effect of air resistance would remain equally minimal as in the case of traditional aircrafts. Hence such a flying machine has a take-off capability of an airship and a forward flying capability of an aircraft.

Taking-off by means of a static lift gives the flying machine in the configuration of a suborbital reusable space shuttle, additional advantages. It is a well known fact that, the biggest problem confronted by space technique is the huge amount of fuel required for sending a space device to a priori set target in space. This problem is avoided in different ways, for example, by dividing the sub-orbital flight in two stages and the flying machine in two flying machines, i. e. a carrier flying machine and a carried flying machine. When released from the carrying flying machine, the carried flying machine would lift only the required amount of fuel for carrying out the second stage. A sub-orbital space shuttle with a take-off capability of an airship and a forward flying capability of an aircraft can as a result of fuel conservation replace a carrier and a carried flying machines and, thereby, realizing enormous savings in the fixed and variable costs.

A sub-orbital reusable space shuttle with a take-off capability of an airship is capable in the unfolded state of carrying out a safe and noiseless vertical take-off without a launch pad or a special airport. The landing in the unfolded state provides equally for a soft and secure landing. Thereby the landing can be accomplished without special airports or parachutes.

In the drawings the subject matter of the invention is represented by way of examples. Shown is:

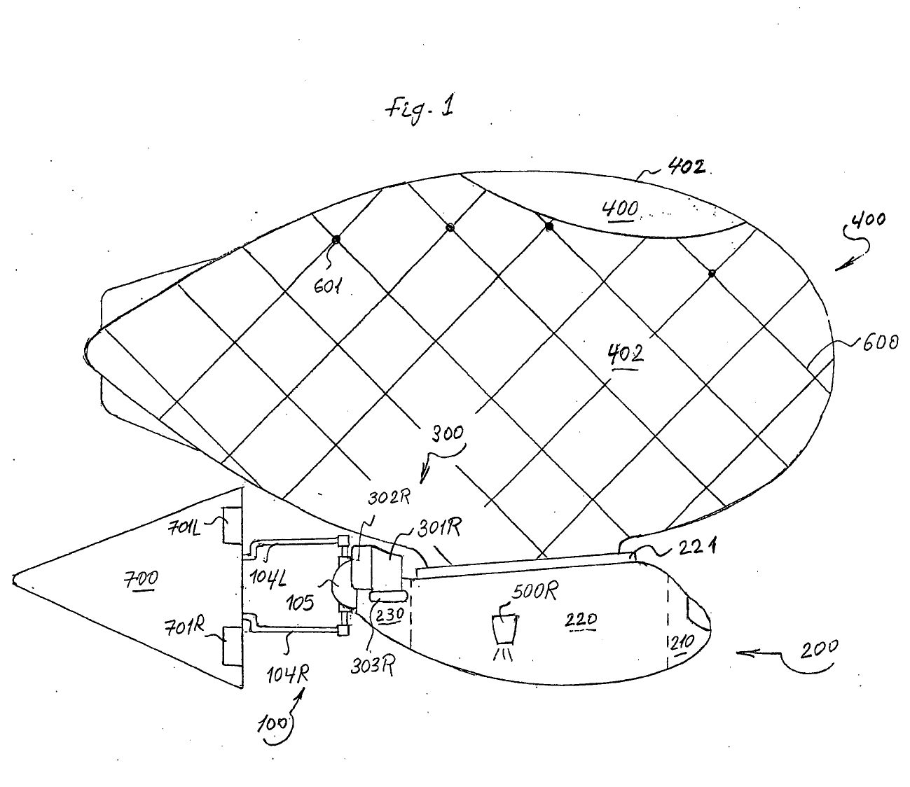

FIG. 1 a schematic side view of an airship which can be unfolded and folded up automatically on the ground and during flight and which can be operated as an aircraft or as a reusable space shuttle, in the unfolded state;

FIG. 2 a schematic partial side view of the aircraft body;

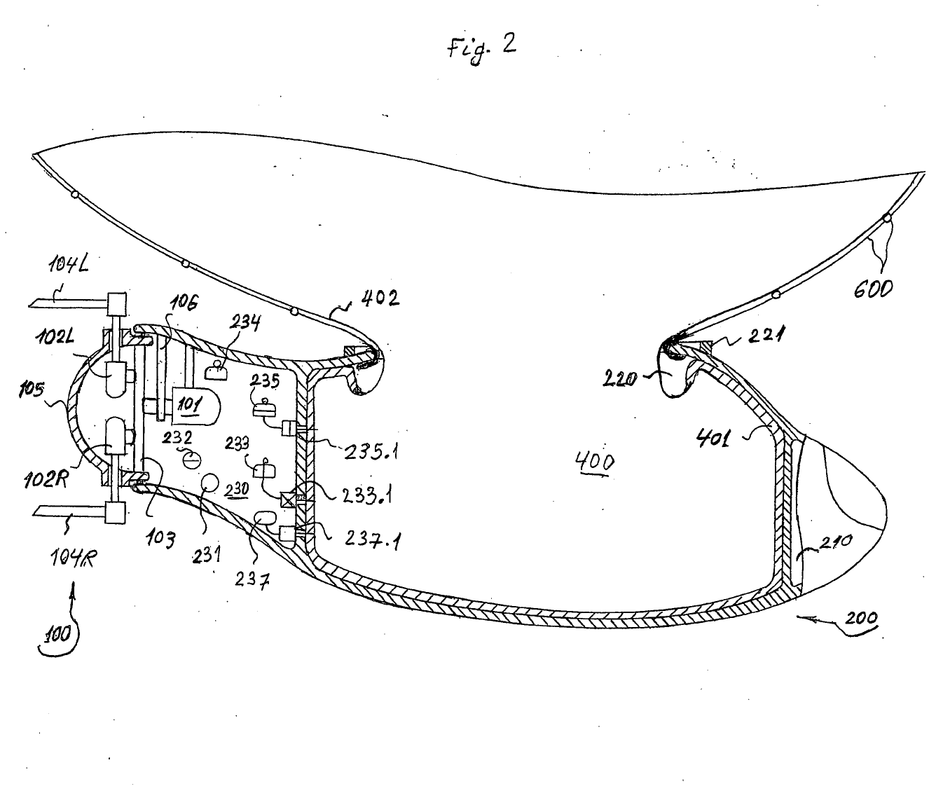

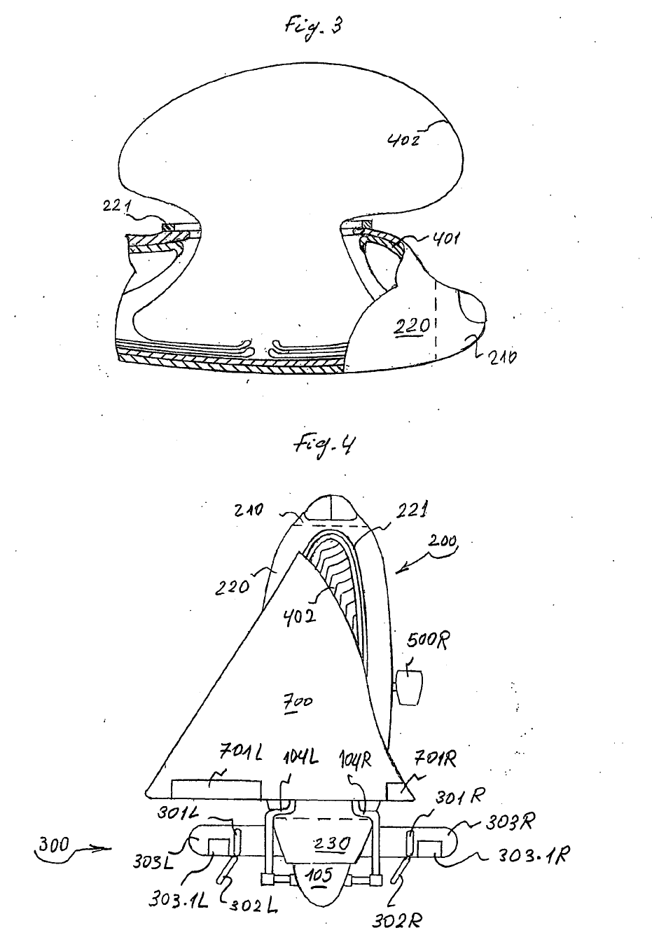

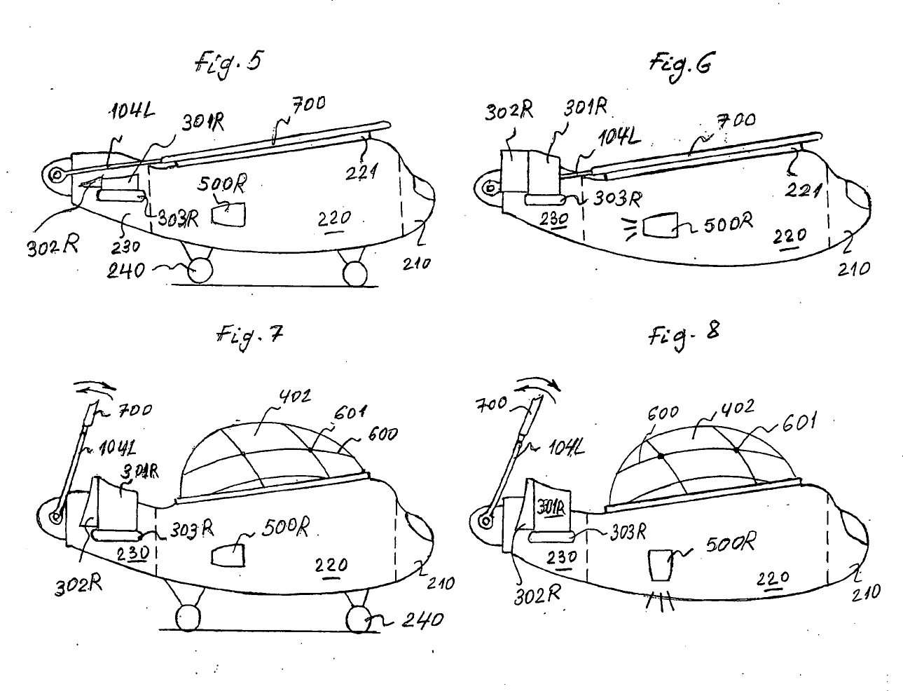

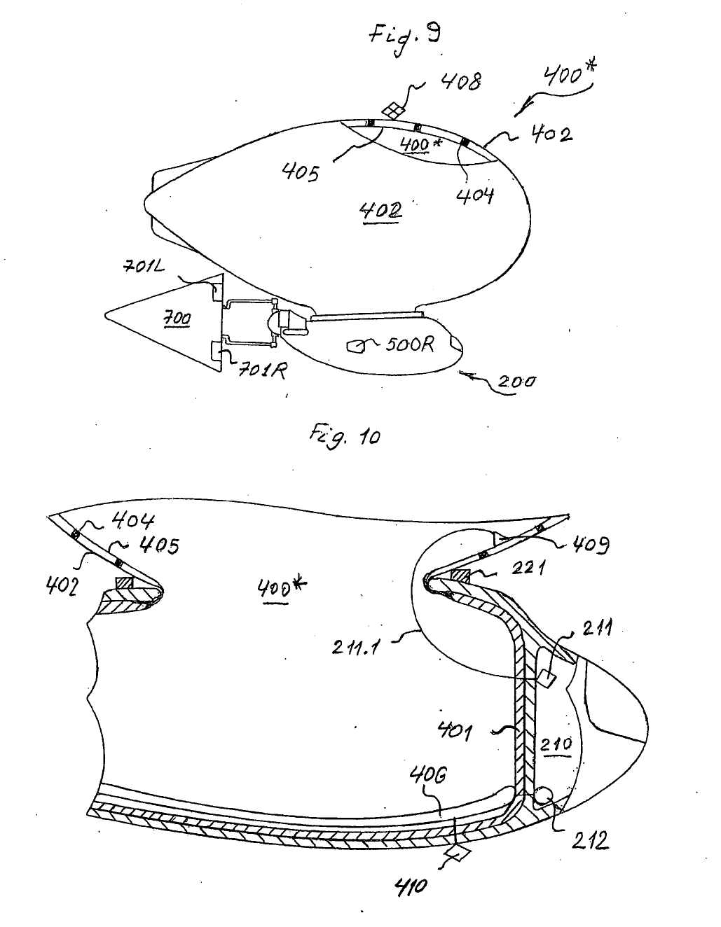

FIG. 3 a schematic partial side view of the combined collapsible gas cell during folding up;

FIG. 4 a schematic top view of an airship which can be unfolded and folded up automatically on the ground and during flight, in the collapsed state;

FIG. 5 a schematic side view of an airship which can be unfolded and folded up automatically on the ground and during flight in the collapsed state on the ground;

FIG. 6 a schematic side view of an airship which can be unfolded and folded up automatically on the ground and during flight in the collapsed state while in flight;

FIG. 7 a schematic side view of an airship which can be unfolded and folded up automatically on the ground and during flight during unfolding or folding up on the ground;

FIG. 8 a schematic side view an airship which can be unfolded and folded up automatically on the ground and during flight during folding up or unfolding while in flight;

FIG. 9 a schematic side view of an airship which can be unfolded and folded up automatically with buoyancy based on a vacuum in the unfolded state;

FIG. 10 a schematic partial side view of the aircraft body with the required components for creating vacuum;

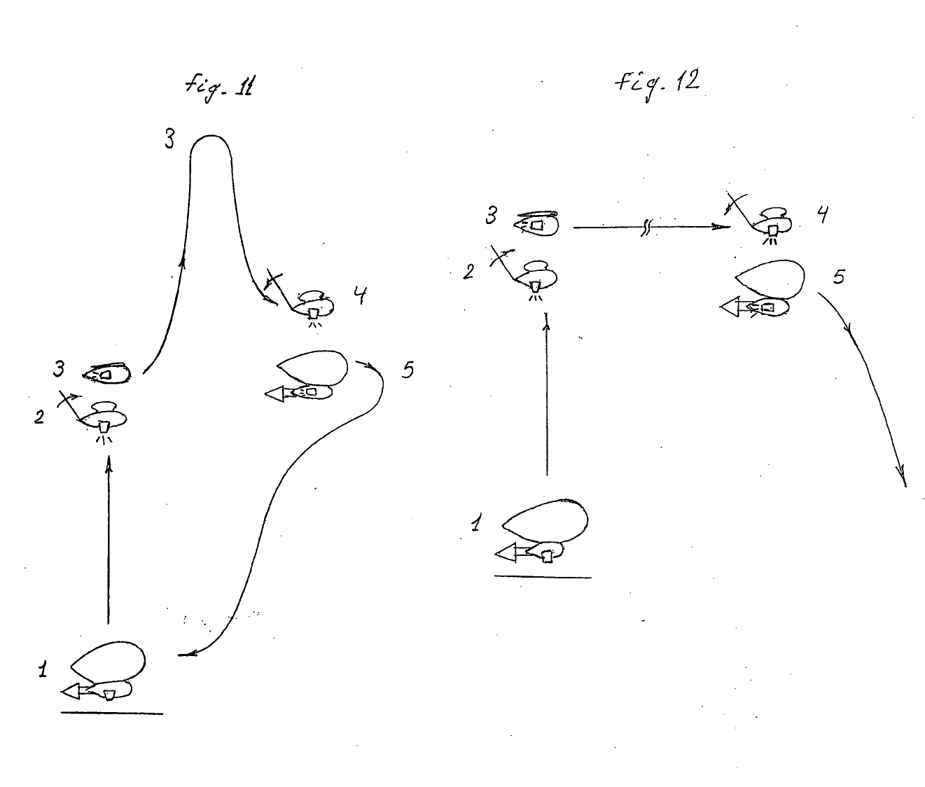

FIG. 11 the route of an airship which can be unfolded and folded up automatically in the configuration of a sub-orbital reusable space shuttle;

FIG. 12 the route of an airship which can be unfolded and folded up in the configuration of an aircraft.

According to FIGS. 1 and 2 an airship which can be unfolded and folded up automatically on the ground and during flight and which can be operated as an aircraft or as a reusable space shuttle, comprises the following main components: a combined collapsible gas cell 400, an aircraft body 200, components for aircraft navigation control 300, two rocket motors 500L and 500R which can be rotated, a collapsible rudder-wing 700 and a mechanism for operation of the collapsible rudder-wing 100.

The aircraft body comprises a cockpit 210, a cargo bay 220, a machine bay 230 and collapsible wheels 240. The combined collapsible gas cell 400 comprises an envelope 402 which can be folded and a housing 401 which cannot be folded. The housing 401 which cannot be folded is mounted on the inner walls and the bottom of the cargo bay 220.

Unfolding and folding up of the airship would be carried out on the ground or while in flight automatically. According to FIG. 7 unfolding and folding up take place on the ground. Folding up on the ground is necessary in order that little space for stationing would be required. According to FIG. 8 folding up and unfolding take place while in flight.

While unfolding the flying machine helium or hydrogen would be drawn from the pressure tank for helium 233 by means of the inlet valve 233.1 or from the pressure tank for hydrogen 235 by means of the inlet valve 235.1 into the combined gas cell 400. Both pressure tanks 233 and 235 are located in the machine bay 230. After filling the combined collapsible gas cell with helium or hydrogen the unfolded airship becomes lighter than the air. In this state the envelop 402 which can be folded would be held by means of the grid network 600 which provides the shape. The latter is fixed on the spots 601 to the top of the envelope 402 and fixed from below to the cargo bay 220.

The collapsible rudder-wing 700 is provided with two flaps 701L and 701R and is operated by means of the mechanism for the operation of the collapsible rudder-wing 100. The latter comprises an electric motor 101, a service brake 106, two electric motors 102L and 102R, three supporting elements 103, 104L and 104R and a rotary barrel 105. The supporting element 103 is fixed from both sides to the inside of the rotary barrel 105. The rotary barrel 105 is pivot mounted in the machine bay 230. The electric motors 102L and 102R are fixed to the supporting element 103 and their shafts are pivot-mounted in the rotary barrel 105. The electric motor 101 is fixed to the supporting element 103 from the shaft and is fixed along with the service brake 106 to the inner wall of the machine bay 230. The supporting element 104L is fixed to the shaft of the electric motor 102L and the supporting element 104R is fixed to the shaft of the electric motor 102R.

The rudder-wing 700 functions in the unfolded state as an airship rudder. In this state it is vertically positioned and it is navigated by means of the electric motors 102L and 102R.

According to FIG. 6 the two rocket motors 500L and 500R, which can be rotated, generate the forward thrust when they are horizontally positioned. According to FIG. 8 they generate the dynamic lift when they are vertically positioned. The rocket motors 500L and 500R are mounted on the aircraft body 200 and function on the basis of burning liquefied hydrogen by means of liquefied oxygen. The liquefied hydrogen is obtainable from the pressure tank for hydrogen 235 and the liquefied oxygen is obtainable from the pressure tank for oxygen 234. The latter is also located in the machine bay 230.

Unfolding and folding up during flight are carried out on the basis of generating the required dynamic lift by means of the rocket motors 500L and 500R. This is necessary in order to enable the flying machine to remain in suspension. Folding up the flying machine starts with the creation of absolute vacuum in the combined collapsible gas cell 400. The helium or hydrogen would be exhausted by means of the vacuum pump 237 which is provided with an outlet valve 237.1. In order to avoid creating excessive pressure in the combined collapsible gas cell 400 during flight, the exhaustion of helium or hydrogen starts at high altitudes while flying in thin air layers. In the case of using helium the vacuum pump 237 would be connected to the liquefaction plant 231 so as to enable liquefying the exhausted helium and retaining it into the pressure tank for helium 233. The fuel cells 232 would be actuated so as to provide electricity for the liquefaction of helium by means of the Liquefaction plant 231. The fuel cells 232 consume hydrogen and oxygen and generate electric current and water. The latter would be disposed off board. The liquefaction plant 231, the vacuum pump 237 and the fuel cells 232 are located in the machine bay 230.

In the case of using hydrogen, the exhausted hydrogen by means of the vacuum pump 237 would be consumed directly by the fuel cells 232 or the rocket motors 500L and 500R.

According to FIG. 3 as a result of exhausting the helium or hydrogen, the envelope 402 which can be folded begins under the impact of vacuum to be pulled towards the inside of the housing 401 which cannot be folded. The grid network 600 would also be pulled into the interior of the housing 401 by means of the envelope 402 which can be folded. Finally under the impact of absolute vacuum, the envelope 402 which can be folded would be compressed together with the grid network 600 inside the housing 401 which cannot be folded.

Thereafter the collapsible rudder-wing 700 would be collapsed. Collapsing the collapsible rudder-wing 700 begins with turning the rotary barrel 105 around its vertical axis by 90°. This could be carried out by means of the electric motor 101 after releasing its shaft from the effect of the service brake 106. As a result the collapsible rudder-wing 700 would be positioned horizontally. Thereupon, the collapsible rudder-wing 700 would be laid down on the cargo bay 220 by means of the electric motors 102L and 102R. In order to avoid laying down the collapsible rudder-wing 700 directly on the storage bay 220, the latter is provided at the top with a sealant 221. By means of a not depicted mechanism, the collapsible rudder-wing 700 would be firmly fixed to the storage bay 220 from a number of points. In order to enable the airship to function as an aircraft in the collapsed state, it is equipped with the components for aircraft navigation control 300. The latter consist of two rudders 302L and 302R, two vertical stabilizers 301L and 301R and two horizontal stabilizers 303L and 303R. The horizontal stabilizer 303L is provided with the elevator 303.1L and the horizontal stabilizer 303R with the elevator 303.1R. Both horizontal stabilizers 303L and 303R are fixed to aircraft body 200 within the limits of the machine bay 230. The vertical stabilizer 301L is fixed to the horizontal stabilizer 303L and the vertical stabilizer 301R to the horizontal stabilizer 303R. The rudder 302R is hinged on the vertical stabilizer 301R and the rudder 302L is hinged on the vertical stabilizer 301L.

According to FIG. 12 the flight route of an airship which can be unfolded and folded up automatically in the aircraft configuration consists of 5 phases. The first phase begins with the vertical take-off. The take-off to the required flight altitude can be carried out by means of a static lift. During the second phase the flying machine would be folded up. The third phase begins with the flight in the aircraft configuration. During the fourth phase the flying machine would be unfolded. The fifth phase begins with the descent in the airship configuration towards the landing site.

According to FIG. 11 the flight route of an airship, which can be unfolded and folded up Automatically, in the configuration of a sub-orbital reusable space shuttle consists also of 5 phases. The first two phases are the same as in the case of aircraft configuration. At the beginning of the third phase the flying machine in the configuration of a reusable space shuttle takes a vertical course toward the targeted altitude in the space. This phase ends after accomplishing the return flight without thrust. The fourth phase begins with unfolding of the flying machine while entering the earth's atmosphere. During this phase the flying machine would be unfolded. The fifth phase begins with the descents of the flying machine in the airship configuration towards the landing site.

According to FIGS. 9 and 10 the combined collapsible gas cell 400* comprises an envelope 402 which can be folded, an inside envelope 405 which can be folded, a housing 401 which cannot be folded and an air envelope 406 which can be folded. The envelope 402 and the inside envelope 405 are connected together by means of the binding elements 404.

The enclosed space between the envelope 402 and the inside envelope 405 can be inflated with air or with a lighter than air gas. For the sake of simplicity, we shall assume that this space is inflated by means of air. Therefore, the exhaust valve 408 and the inlet valve 409 were designated. The exhaust valve 408 is fixed to the envelope 402 from the outside. The inlet valve 409 is fixed to the inside envelope 405 from the inside.

The air pump 211 is located in the cockpit 210. It is connected to the inlet valve 409 by means of the pipe 211.1. Generating an appropriate pressure in the enclosed space between the envelope 402 which can be folded and the inner envelope 405 which can be folded would create the desired aerodynamic shape of the envelope 402 and at the same time a vacuum inside the combined gas cell 400*.

A lighter than air airship, which can fly by means of a vacuum is known from GB 1345288. The application of this principle to an airship capable of automatically unfolding and folding up on the ground as well as while in flight is rather appropriate because of the acceleration of the process of unfolding and folding up.

Obtaining an absolute vacuum in the combined collapsible gas cell 400* might require excessive use of materials. That is why little quantity of helium or hydrogen could be pumped into the gas cell so as to enable creating some opposing pressure from inside.

Unfolding the airship begins with pumping air into the enclosed space between the envelope 402 and the inside envelope 405. At the same time the combined collapsible gas cell 400* would be supplied with a little quantity of helium or hydrogen for creating the opposing pressure. The folding up begins with the opening of the exhaust valve 408 and exhausting the helium or the hydrogen from the combined collapsible gas cell 400*.

In order to enable the landing of the flying machine in the configuration of an airship, the air envelope 406 was designated. The latter is equipped with a vacuum pump 212 and an inlet valve 410. As soon as the inlet valve 410 is opened, the outside air flows into the inside of the air envelope 406 and the airship becomes heavier than air. The air can then be exhausted from the collapsible envelope 406 by means of the vacuum pump 212 so as to enable the airship to become lighter than the air once again. The vacuum pump 212 is located in the Cockpit 210.

What I claim is:

1) An airship which can be unfolded and folded up automatically on the ground and during flight and which can be operated as an aircraft or as a reusable space shuttle, having a combined collapsible gas cell (400), a grid network (600) which provides the shape, an aircraft body (200) comprising a cockpit (210), a cargo bay (220), a machine bay (230) and collapsible wheels (240), components for aircraft navigation control (300), two rocket motors (500L, 500R) which can be rotated, a collapsible rudder-wing (700), a mechanism for operation of the collapsible rudder-wing (100), a liquefaction plant for Helium (231), fuel cells (232), a pressure tank for helium (233), a pressure tank for oxygen (234), a pressure tank for hydrogen (235), a vacuum pump (237), wherein the combined collapsible gas cell (400) comprises an envelope (402) which can be folded and a housing (401) which cannot be folded, the housing (401) which cannot be folded is mounted on the inner walls and the bottom of the cargo bay (220), the combined collapsible gas cell (400) is filled with helium or hydrogen in the unfolded state, and is completely empty in the collapsed state, the envelope (402) which can be folded is held by the grid network (600) which provides the shape when in the unfolded state, and is located along with grid network (600) in the internal area of the housing (401),which cannot be folded, in the collapsed state.

2) An airship which can be unfolded and folded up automatically on the ground and during flight according to claim 1, wherein the combined collapsible gas cell (400*) comprises an envelope (402) which can be folded, an inside envelope (405) which can be folded, a housing (401) which cannot be folded and an air envelop (406) which can be folded, the envelope (402) which can be folded and the inside envelope (405) which can be folded are connected together by means of the binding elements (404), the exhaust valve (408) is fixed to the envelope (402) from the outside, the inlet valve (409) which is connected to the air pump (211), is fixed to the inside envelope (405) from the inside, the air envelop (406) which can be folded is equipped with the inlet valve (410) and the vacuum pump (212).

3) An airship which can be unfolded and folded up automatically on the ground and during flight according to claim 1, wherein the mechanism for operation of the collapsible rudder- wing (100) comprises an electric motor (101), a service brake (106), two electric motors (102L, 102R), three supporting elements (103, 104L, 104R) and a rotary barrel (105), whereas the supporting element (103) is fixed from both sides to the rotary barrel (105) from the inside, the rotary barrel (105) is pivot mounted in the machine bay (230), the electric motors (102L, 102R) are fixed to the supporting element (103) and their shafts are pivot mounted in the rotary barrel (105), the electric motor (101) is fixed on the part of its shaft to the supporting element (103) and fixed along with the service brake (106) to the inside wall of the machine bay (230), the supporting element (104L) is fixed to the shaft of the electric motor (102L) and the supporting element (104R) is fixed to the shaft of the electric motor (102R).

4) An airship which can be unfolded and folded up automatically on the ground and during flight according to claim 3, wherein the collapsible rudder-wing (700) is provided with two flaps (701L, 701R) and fixed to the supporting elements (104L, 104R), whereas when the rudder-wing (700) is being used as an airship rudder in the unfolded state it would be vertically positioned and steered by means of the electric motors (102L, 102R) and when it is being used as an aircraft wing in the collapsed state it would be horizontally positioned and tightly clamped over the cargo bay (220).

5) An airship which can be unfolded and folded up automatically on the ground and during flight according to claim 1, wherein the components for aircraft navigation control (300) comprise two rudders (302L, 302R), two vertical stabilizers (301L, 301R) and two horizontal stabilizers (303L, 303R), the horizontal stabilizer (303L) which is provided with the elevator (303.1L) and the horizontal stabilizer (303R) which is provided with the elevator (303.1R) are fixed to the aircraft body (200), the vertical stabilizer (301L) is fixed to the horizontal stabilizer (303L) and the vertical stabilizer (301R) is fixed to the horizontal stabilizer (303R), the rudder (302R) is hinged on the vertical stabilizer (301R) and the rudder (302L) is hinged on the vertical stabilizer (301L).

6) An airship which can be unfolded and folded up automatically on the ground and during flight according to claim 1, wherein the cargo bay (220) is provided with a sealant (221).

7) (not entered)

8) (not entered)
